(19) United States
(12) Patent Application Publication
(10) Pub. No.: US 2022/0280371 A1
(43) Pub. Date: Sep. 8, 2022

(54) Self-Operable Massage Therapy Device

(71) Applicant: Jeremiah Dekle, South Jordan, UT (US)

(72) Inventor: Jeremiah Dekle, South Jordan, UT (US)

(21) Appl. No.: 17/686,173

(22) Filed: Mar. 3, 2022

Related U.S. Application Data
(60) Provisional application No. 63/155,907, filed on Mar. 3, 2021.

(51) Int. Cl. A61H 7/00; A61H 15/00

(52) U.S. Cl. CPC A61H 7/007; A61H 15/0085; A61H 2205/062; A61H 2205/081; A61H 2201/0153; A61H 2201/1253; A61H 2201/1626; A61H 2201/1616; A61H 2201/1611; A61H 2205/04

(57) ABSTRACT

A massage device that includes a dorsal brace, a dorsal projection, and a first and second arm. The dorsal projection attaches to the dorsal brace. The first arm connects to a first end of the dorsal brace and the second arm connects to a second end of the dorsal brace. Both arms extend in the same direction and are substantially parallel to each other. Also disclosed is a massage device that includes a dorsal brace, a plurality of dorsal projections, and a first and second arm. One or more of the plurality of dorsal projections attach to the dorsal brace. The first arm connects to a first end of the dorsal brace and the second arm connects to a second end of the dorsal brace. Both arms extend in the same direction and are substantially parallel to each other.

### PRIORITY CLAIM

This application claims priority to, and benefit of, U.S. Provisional Application No. 63/155,907 filed on Mar. 3, 2021, which is hereby incorporated by reference.

### TECHNICAL FIELD

The disclosure relates generally to a self-operable massage therapy device which allows a user to massage the user's own neck, back, and shoulder while maintaining the arms in an ergonomic and relaxed position. This facilitates a massage therapy session that increases the productivity of a massage and the massage experience for the user.

### BACKGROUND

Since ancient times healers have used a wide array of tools and medicines to reduce the physical pain and suffering of humanity, some which actually had therapeutic effect and others which are seen in modern eyes as being barbaric. As technological advances were made due to an increased understanding of the human body, many of these barbaric technologies were discontinued while effective technologies were developed to improve baseline results. One technique used in both ancient and modern times is massage therapy. Massage therapy dates back 5000 years to the Indian subcontinent. In greater Asia, massage therapy techniques were developed culminating in 2700 BC in China with a writing concerning massage therapy. Massage therapy later spread to Japan, Egypt, Greece, and then to Rome. New massage therapy techniques developed as knowledge of massage therapy spread and was practiced throughout the world.

Developments and advances in massage therapy have produced many different types of massage such as shiatsu, Swedish, deep tissue, Thai, trigger point, hot stone, reflexology etc. Even with the developments in massage therapy one constant has remained: a need for another individual to perform the massage on a person. Having another person performing the massage allowed the user of the massage to remain in a relaxed position providing a more effective and relaxing experience. Reliance on another person, however, is difficult when a person experiencing muscle pains needs to wait for the availability of a trained massage therapist. Currently, schools, programs, degrees, and certifications have been developed to train massage therapists in different techniques. As training for massage therapists increases so does the expense to the individual seeking a massage. Moreover, an appointment with a massage therapist may be inconvenient, or not possible, due to the amount of time necessary for a thorough treatment.

Efforts have been made to produce tools that allow an individual to self-massage to avoid significant time and financial commitments while providing some massage benefit to an individual. Some types of tools produced include large foam rollers and massage balls. Massage balls and foam rollers, for example, often require an individual to roll on the ground over the rollers or the massage balls to massage the hip or the back which can be difficult for individuals with mobility limitations. Foam rollers and massage balls do not allow the user to be relaxed and, while in use, the user is not often ergonomically positioned due to the awkwardness and instability of a person using these tools.

Another development is a massage gun with a percussive end. The gun, when used one handed by a user massaging his own back, is not as effective on hard-to-reach places such as the back of the legs and muscles near the spine and between the shoulder blades. Another popular massage tool is a massage roller that is shaped similarly to a rolling pin but instead of smooth surface for rolling includes several balls for rolling against a muscle. However, this particular massage tool requires another individual to use on hard-to-reach places such as the muscles near the spine and between the shoulder blades. If a user attempts to self-massage his or her back the roller massage may require using one hand and, because of the position of the arm, the user will have difficulty adding or lessening pressure on the back. A final example of another tool that allows a back massage without requiring another individual, is a massage chair. Unfortunately, massage chairs are bulky and expensive and, for many people, seem to provide more vibration than massage. Massage chairs are generally a one size fits all which does not conform to all body types and fails to appreciate atypical spine curvatures such as people suffering from scoliosis, kyphosis, and lordosis.

### SUMMARY

Disclosed herein is a massage device that includes a dorsal brace, a dorsal projection, and a first and second arm. The dorsal projection attaches to the dorsal brace. The first arm connects to a first end of the dorsal brace and the second arm connects to a second end of the dorsal brace. Both arms extend in the same direction and are substantially parallel to each other. Also disclosed is a massage device that includes a dorsal brace, a plurality of dorsal projections, and a first and second arm. One or more of the plurality of dorsal projections attach to the dorsal brace. The first arm connects to a first end of the dorsal brace and the second arm connects to a second end of the dorsal brace. Both arms extend in the same direction and are substantially parallel to each other.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings:

FIG. 1 illustrates a perspective view of a massage therapy device.

FIG. 2A illustrates a side view of a massage therapy device.

FIG. 2B illustrates a back view of a massage therapy device.

FIG. 2C illustrates a top view of a massage therapy device.

FIG. 3 illustrates a perspective view of a massage therapy device being implemented by a user.

FIG. 4A illustrates a back view of an alternative embodiment of a massage therapy device.

FIG. 4B illustrates a top view of an alternative embodiment of a massage therapy device.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

It should be appreciated that one or more exemplary embodiment of the massage therapy device may include electrical components allowing the massage therapy device to selectively implement heat, percussive, vibration and other qualities and corresponding components to the one or more portions of the massage therapy device that contacts the body of a user. The electrical components may be positioned selectively on or within the massage therapy device to balance the weight and to promote ergonomic ease of its use.

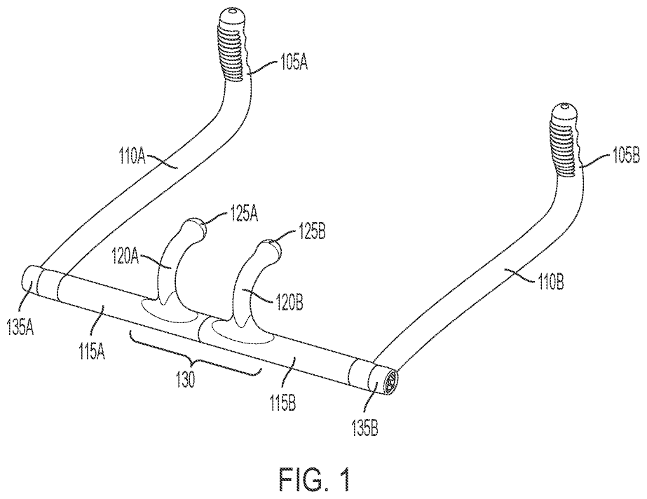

FIG. 1 illustrates a perspective view of massage therapy device 100. Massage device 100 may include handles 105A and 105B and may be connected to arms 110A and 110B, respectively. Handles 105A and 105B may be positioned at a fixed angle that may be substantially perpendicular to a plane defined by the length of arms 110A and 110B. Substantially perpendicular in this context is intended to mean plus or minus 15 degrees. Alternatively, the connection between handles 105A and 105B and arms 110A and 110B may include an articulable joint that further may be locked in place at a certain angle, for example. In an embodiment where massage device 100 includes electrical components a switch may be included on the handle 105A and/or 105B. Additionally, the connection to handles 105A and 105B may be implemented as single pieces or selectively disconnectable and interchanged with another set of handles 105A and 105B. Furthermore, removing handles 105A and 105B may facilitate storing massage device 100 in a convenient space saving configuration.

Arms 110A and 110B may connect to handles 105A and 105B on the distal end of arms 110A and 110B. The proximal ends of arms 110A and 110B may be connected and/or removably connected to dorsal braces 115A and 115B, respectively. Arms 110A and 110B may extend off in the same direction and be substantially perpendicular to each other. Substantially perpendicular in this context means plus or minus fifteen degrees. The connection between dorsal braces 115A and 115B and arms 110A and 110B may include connectors 135A and 135B. Connectors 135A and 135B may include an articulable joint that further may be locked in place at a certain angle. Further, connectors 135A and 135B may be detachably connected and may be exchanged with one or more different arms 110A and 110B. Arms 110A and 110B may be adjustable through telescoping adding or removing a section of arms 110A and 110B etc. Adjusting arms 110A and 110B allows massage device 100 to fit the body dimensions of the user. Additionally, arms 110A and 110B may contain various curves or bends for comfort and/or effectiveness.

Dorsal Brace 115A may connect to arm 110A and to dorsal coupler 130 as one or more individual pieces which make up dorsal brace 115A. In a similar manner, dorsal brace 115B may connect to arm 110B and to dorsal coupler 130 as one or more individual pieces which make up dorsal brace 115B. Dorsal braces 115A and 115B may be fixed or may be adjustable through telescoping and or adding and removing sections etc. In another embodiment, dorsal brace 115A may span the entire proximal side of massage device 100. In so doing, dorsal brace 115A may connect to arm 110A on a first end and connect to arm 110B on a second end such that dorsal brace 115B is omitted. Connectors 135A and 135B may connect to dorsal braces 115B and 115A to arms 110A and 110B respectively. Further dorsal brace 115A may connect directly to a dorsal projection 120A and/or 120B. Further coupler 130 may be connected to dorsal brace 115A and/or 115B and further may be connected to one or more dorsal projections 120A and 120B. In a different embodiment dorsal projections 120A and 120B may be connected directly to dorsal brace 115A and/or 115B.

Dorsal projections 120A and 120B extend from massage device 100 at an angle from a plane defined by the length of arms 110A and 110B. The angle in the bend may be substantially 90 degrees. “Substantially” in this context is plus or minus 15 degrees. Dorsal projections 120A and 120B may include a bend that may extend dorsal projections 120A and 120B distally. Such that portion of dorsal projections 120A and 120B below the bend are at an angle relative to the portions of dorsal projections 120A and 120B above the bend. In one embodiment, this angle may be substantially 90 degrees. “Substantially” in this context is plus or minus 15 degrees. Alternatively, dorsal projection 120A may include a different angle than the angle of dorsal projection 120B. Dorsal brace 115A and 115B may further be a single piece 115A. Dorsal projection 120A may be positioned closer to a first end of dorsal brace 115A. Dorsal projection 120B may be positioned closer to a second end of 115A. Further, the distance between the 120A and the first end of dorsal brace 115A may be the same distance as dorsal projection 120B and the second end of dorsal brace 115A. Alternatively, one or more dorsal projections may be place on any portion of dorsal brace 115A and or 115B. Also, massage device 100 may only include dorsal projection 120A or may contain a plurality of dorsal projections 120A, 120B etc. In a different embodiment a space in between dorsal projections 120A and 120B and the angle of the dorsal projections 120A and 120B may be adjustable. Dorsal projections 120A and 120B may include massage heads 125A and 1258 attached to an end of dorsal projections 120A and 120B, respectively. The other end of massage heads 125A and/or 1258 may be attached to coupler 130 or directly to one or more of dorsal brace 115A and 115B. Heads 125A and 1258 may be interchangeably connected to dorsal projections 120A and 120B such that heads 125A and 125B may be switched out for heads 125A and 125B of different shape, size material or other distinct qualities. In an embodiment where the massage device contains electric components, heads 125A and 125B may be percussive and/or contain a heating element to enhance the massaging effect.

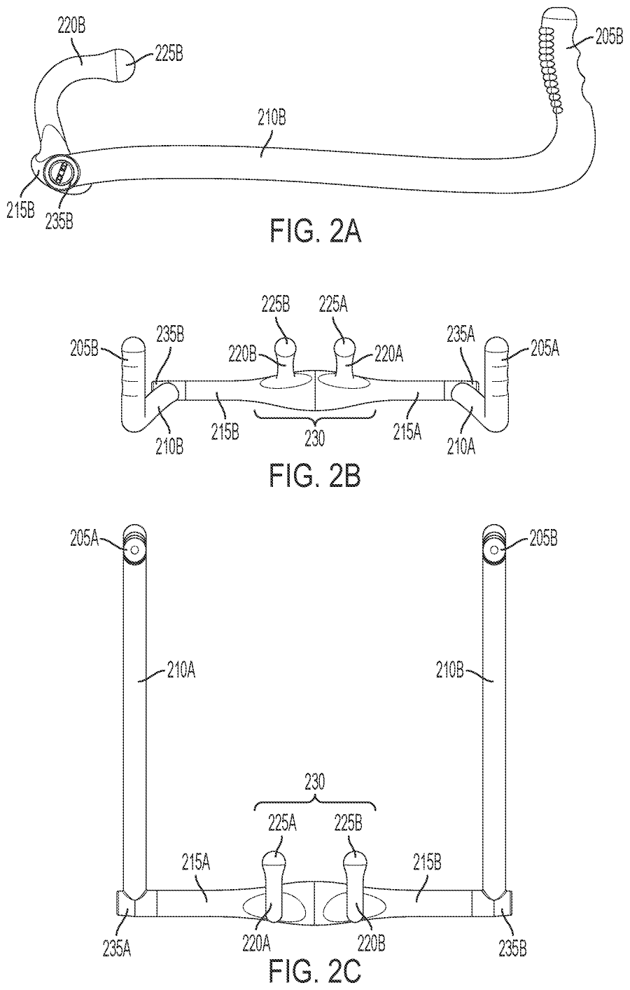

FIG. 2 illustrates a side view (FIG. 2A), back view (FIG. 2B), and top view (FIG. 2C) of a massage therapy device 200. FIG. 2A is a side view depiction which depicts a side of massage device 200A. A complimentary side of massage device 200A, which is not shown due to perspective, may include similar components in a similar arrangement. Massage device 200A may include handle 205B connected to arm 210B that may be substantially perpendicular to the length of arm 210B. “Substantially” in this context means plus or minus 15 degrees. In an alternative embodiment, the connection between handle 205B and arm 210B may articulate such that the angle between handle 205B and arm 210B may adjust selectively. Arm 210B may be connected to handle 205B at a first end and to dorsal brace 215B at a second end using connector 235B. Connector 235B may allow the removal of arm 210B. Also, connector 235B may allow the arm 215 to rotate around an axis point defined by the length of dorsal brace 215B. Dorsal brace 215B may also be connected to dorsal coupler 230. Dorsal projection 220B may be connected to dorsal coupler 230 or may be connected directly to dorsal brace 215B, omitting dorsal coupler. Dorsal projection 220B may extend from dorsal coupler 230 or dorsal brace 215 at substantially a 90-degree angle as defined by a plane extending through the length of arms 210A and 210B. Substantially means plus or minus 15 degrees.

Dorsal projection 220 may include an additional bend such that the portion of the of dorsal projection before the bend may be substantially perpendicular to the portion of dorsal projection 220 after the bend. Again, “substantially” in this context means plus or minus 15 degrees. Dorsal brace 215A and 215B may further be a single piece 215A. Dorsal projection 220A, with a single piece dorsal brace 215A, may be positioned closer to a first end of dorsal brace 215A. Dorsal projection 220B may be positioned closer to a second end of 215A. Further, the distance between the 225A and the first end of dorsal brace 215A may be the same distance as dorsal projection 220B and the second end of dorsal brace 215A. Alternatively, one or more dorsal projections may be placed on any portion of dorsal brace 215A and or 215B. Connected to an end of dorsal projection 220B is massage head 225B. Massage head 225B may contain various types of material that include but are not limited to synthetic material or natural material e.g., rubber, polyurethane, foam, leather, wood, metal, silicone, stone. Massage head 225B may be interchangeable with other heads shapes or material.

FIG. 2B depicts a back view of massage therapy device 200B. Massage device 200B may include handles 205A and 205B which may be connected to arms 210A and 210B, respectively. Handles 205A and 205B may extend from arms 210A and 210B at a fixed angle that is substantially perpendicular. “Substantially” in this context means plus or minus 15 degrees. The connection between handles 205A and 205B and arms 210A and 210B alternatively may be articulated to allow the angle to be adjusted. The new angle between handles 205A and 205B and arms 210A and 210B may further be locked in place. In an embodiment of massage device 200B includes electrical components a switch may be included on the handle 205A and/or 205B. Additionally, the connection to handles 205A and 205B may be selectively disconnected and interchanged with another set of handles 205A and 205B. Furthermore, removing handles 205A and 205B may aid in storing massage device 200B.

Arms 210A and 210B may connect to handles 205A and 205B on the distal end of arms 210A and 210B. The proximal ends of arms 210A and 210B may be connected and/or removably connected to dorsal braces 215A and 215B, respectively. This connection may be facilitated by connectors 235A and 235B. Arms 210A and 210B may be adjustable through telescoping adding or removing a section of arms 210A and 210B. Adjusting arms 210A and 210B allows massage device 200B to fit the body dimensions of the user. Additionally, arms 210A and 210B may contain various curves or bends for comfort and/or effectiveness.

Dorsal Brace 215A may connect to arm 210A at a first end and to dorsal coupler 230 at a second end. In a similar manner, dorsal brace 215B may connect to arm 210B at a first end and to dorsal coupler 230 at a second end. Dorsal braces 215A and 215B may be fixed or may be adjustable through telescoping and or adding and removing sections. In another embodiment dorsal brace 215A may span the entire proximal side of massage device 200B. In so doing, dorsal brace 215A may connect to arm 210A on a first end and connect to arm 210B on a second end such that dorsal brace 215B is omitted. Dorsal coupler 230 may be connected to dorsal brace 215A and/or 215B and further may be connected to dorsal projections 220A and 220B. In a different embodiment dorsal projections 220A and 220B may be connected directly to dorsal brace 215A and/or 215B.

Dorsal projections 220A and 220B extend from massage device 200B at substantially a 90-degree angle from a plane defined by the length of arms 210A and 2108. “Substantially” in this context is plus or minus 15 degrees. Dorsal projections 220A and 220B may include a bend that may extend dorsal projection 220A and 220B distally such that a portion of dorsal projections 220A and 220B below the bend are substantially perpendicular to the portions of dorsal projections 220A and 220B above the bend. “Substantially” in this context is plus or minus 15 degrees. Alternatively, dorsal projection 220A may be disposed at an angle that is different from dorsal projection 220B. Also, massage device 200B may only include dorsal projection 220A or may contain a plurality of dorsal projections 220A, 220B, and so on. In a different embodiment a space in between dorsal projections 220A and 220B may be adjustable. Furthermore, dorsal projections 220A and 220B may include massage heads 225A and 225B attached to the end of dorsal projections 220A and 220B, respectively. Heads 225A and 225B may be interchangeably connected to dorsal projections 220A and 220B such that heads 225A and 225B may be switched out for heads 225A and 225B of different shape, size, and/or other distinct qualities. In an embodiment where the massage device contains electric components, heads 225A and 225B may be percussive and/or contain a heating element to enhance the massaging effect.

FIG. 2C depicts top view of massage therapy device 200C. Massage device 200C may include handles 205A and 205B which may be connected to arms 210A and 210B, respectively. Handles 205A and 205B may extend from arms 210A and 210B at a fixed angle that is substantially perpendicular. “Substantially” in this context means plus or minus 15 degrees. The connection between handles 205A and 205B and arms 210A and 210B alternatively may be articulated to allow the angle to be adjusted. The new angle between handles 205A and 205B and arms 210A and 2108 may further be locked in place. In an embodiment of massage device 200B includes electrical components a switch may be included on the handle 205A and/or 205B. Additionally, the connection to handles 205A and 205B may be selectively disconnected and interchanged with another set of handles 205A and 205B. Furthermore, removing handles 205A and 205B may aid in storing massage device 200B.

Arms 210A and 210B may connect to handles 205A and 205B on the distal end of arms 210A and 2108. The proximal ends of arms 210A and 210B may be connected and/or removably connected to dorsal braces 215A and 2158, respectively. Connection between dorsal braces 215A and 215B and arms 210A and 210B massage device 200 may include connectors 235A and 235B. Connectors 235A and 235B may include an articulable joint that further may be locked in place at a certain angle. Further, connectors 235A and 235B may be detachable connected and may be exchanged with one or more different arms 210A and 2108.

Arms 210A and 210B may be adjustable through telescoping, adding, or removing a section of arms 210A and 2108. Adjusting arms 210A and 210B allows massage device 200B to fit the body dimensions of the user. Additionally, arms 210A and 210B may contain various curves or bends for comfort and/or effectiveness.

Dorsal brace 215A may connect to arm 210A at a first end and to dorsal coupler 230 at a second end. In a similar manner, dorsal brace 2158 may connect to arm 210B at a first end and to dorsal coupler 230 at a second end. Dorsal braces 215A and 2158 may be fixed or may be adjustable through telescoping and or adding and removing sections. In another embodiment dorsal brace 215A may span the entire proximal side of massage device 200C. In so doing, dorsal brace 215A may connect to arm 210A on a first end and connect to arm 210B on a second end such that dorsal brace 215B is omitted. Dorsal coupler 230 may be connected to dorsal brace 215A and/or 215B and further may be connected to one or more of dorsal projections 220A and 220B. In a different embodiment dorsal projections 220A and 220B may be connected directly to dorsal brace 215A and/or 2158.

Dorsal projections 220A and 220B may extend from massage device 200C at substantially a 90-degree angle from a plane defined by the length of arms 210A and 2108. “Substantially” in this context is plus or minus 15 degrees. Dorsal projections 220A and 220B may include a bend that may extend dorsal projection 220A and 220B distally. Such that a portion of dorsal projections 220A and 220B below the bend are substantially perpendicular to the portions of dorsal projections 220A and 220B above the bend. “Substantially” in this context is plus or minus 15 degrees. Alternatively, dorsal projection 220A may be disposed at an angle different from that of dorsal projection 220B. Also, massage device 200C may only include dorsal projection 220A or may contain a plurality of dorsal projections 220A, 220B etc. In a different embodiment a space in between dorsal projections 220A and 220B may be adjustable. Furthermore, dorsal projections 220A and 220B may include massage heads 225A and 225B attached to the end of dorsal projections 220A and 220B, respectively. Heads 225A and 225B may be interchangeably connected to dorsal projections 220A and 220B such that heads 225A and 225B may be switched out for heads 225A and 225B of different shape, size, and or other distinct qualities. In an embodiment where the massage device contains electric components, heads 225A and 225B may be percussive and/or contain a heating element to enhance the massaging effect.

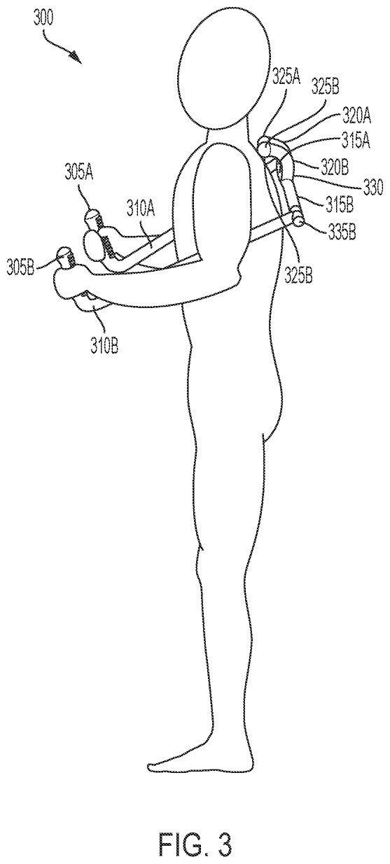

FIG. 3 illustrates a perspective view of massage therapy device 300 being implemented by a user. In FIG. 3, massage therapy device 300 is shown and described in a “right side up” orientation. However, it is possible that the user may choose to use massage therapy device 300 in an “upside down” orientation to massage portions of a user's lower back without departing from the scope or spirit of this disclosure. Further, connector 335B, for example, may allow dorsal braces 315A/315B to rotate to allow dorsal projections 320A and 320B to be disposed in an “upside down” configuration by rotating dorsal projections 320A and 320B to extend downwardly (opposite the direction shown in FIG. 3) while handles 305A and 305B maintain an “right side up” orientation. Dorsal projections 320A and 320B may also be rotatable about to allow heads 325A and 325B to contact the user's back when the dorsal projections 320A and 320B are in an “upside down” configuration and handles 325A and 325B are in a “right side up” orientation.

As shown in FIG. 3, the hands of the user may grip handles 305A and 305B with the right and the left hand, respectively. Handles 305A and 305B may be connected to arms 310A and 310B. In one embodiment these connections may articulate. Also, arms 310A and 310B may be extendable to adjust according to the biometrics of the user. To adjust, arms 310A and 310B may be telescoping or may include additional section to be added to arms 310A and 310B. Arms 310A and 310B may connect do dorsal braces 315A and 315B by connectors 335A (not seen due to perspective but similarly depicted as 135A in FIGS. 1 and 135A in FIGS. 2A and C) and connector 1358 respectively. This may allow the exchange of different arms and may facilitate the adjustment of the angle degree from the dorsal braces 135A and 135B.

When in use, arms 310A and 3108 may extend underneath the arms of the users. Alternatively, arms 310A and 3108 may extend over top of the arms of the user while in use. Arm 310A may connect to right dorsal brace 315A and arm 3108 may connect to left dorsal brace 3158. In a distinct embodiment dorsal brace 3158 may be adjustable to shorten or lengthen according to the biometrics of the user. Left dorsal brace 3158 which may include adding or removing a section or alternatively lengthening and or shortening by telescoping. Right dorsal brace 315A may have similar features as left dorsal brace 3158. Right dorsal brace 315A and left dorsal brace 3158 may connect to dorsal coupler 330. Dorsal coupler 330 may connect to dorsal projections 320A and 320B. One or more of dorsal projections 320A and 320B may connect directly to one or more of dorsal brace 315A and 3158.

Alternatively, there may only be a single dorsal projection 320B. Dorsal projections may extend from dorsal coupler 330 at substantially a 90-degree angle from a plane defined by the length of arms 310A and 3108. “Substantially,” in this context means plus or minus 15 degrees. Heads 325A and 325B may be attached to the end of dorsal projections 320A and 320B. In an alternative embodiment that contains a single dorsal projection 320B only single head 325B may be needed. The massage heads 325A and 325B are positioned facing the back of the user and may be adjusted on the back by the bending of the writs and/or raising of the forearms.

Furthermore, increasing pressure between the heads 325A/325B and the body of the user may be accomplished through a minor ulnar deviation of the wrist and/or elbow extension and/or shoulder flexion. To decrease pressure between the heads 325A/325B and the back of the user may be accomplished through a minor radial deviation and/or elbow flexion and/or shoulder extension. This allows the elbow to be in close proximity to the body decreasing physiological strain and giving the user a mechanical advantage of putting the arm in a position to best take advantage of major muscles such as the biceps, triceps and deltoid.

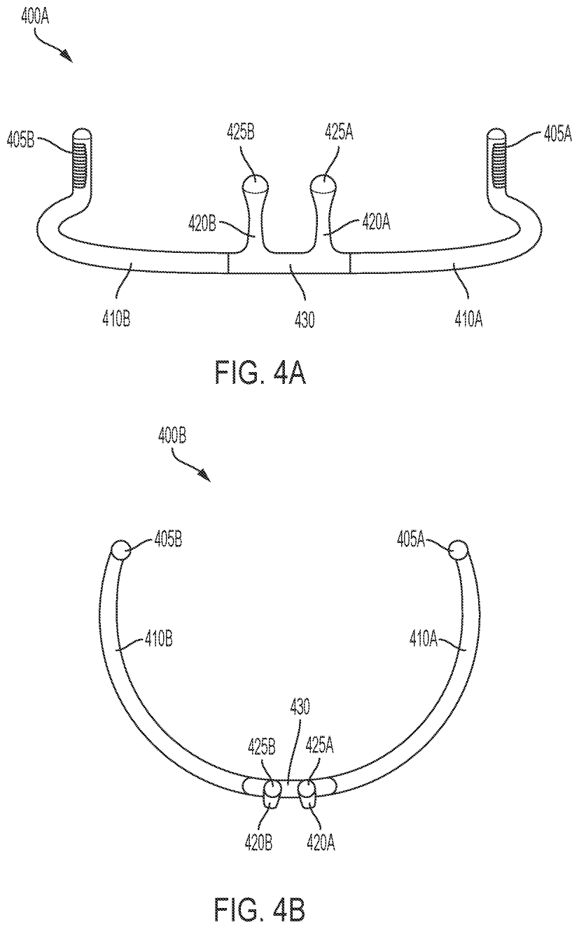

FIG. 4 illustrates a back view (FIG. 4A) of an alternative embodiment massage device 400A and a top view (FIG. 4B) of an alternate embodiment massage device 400B. Massage device 400A and 400B may include handles 405A and 405B which may be connected to the distal end of arms 410A and 410B, respectively. Arms 410A and 410B in this embodiment are arched and connect directly to dorsal coupler 430. This bend of arms 410A and 410B may or may not extend around the outside of the elbow of the user while in use. The length of arms 410A and 410B may be adjustable e.g., telescoping or adding/removing of a section of arms 410A and 410B.

The connection between handles 405A and 405B and arms 410A and 410B may be fixed such that handles are substantially perpendicular to a plane defined by the length of the arms 410A and 410B. “Substantially” in this context means plus or minus 15 degrees. Alternatively, the connection between handles 405A and 405B and arms 410A and 410B may include an articulable joint that further may be locked in place. Furthermore, in embodiments that include electrical components a switch or a dial may be located on the handle 405A and/or 405B. Additionally, the connection to handles 405A and 405B may be selectively disconnected and this may aid in the storing of the device.

Arms 410A and 4108 may connect to handles 405A and 405B on the distal end of arms 410A and 4108. The proximal ends of arms 410A and 4108 may be connected and/or removably connected to dorsal coupler 430. Dorsal coupler 430 may connect to dorsal projections 420A and 420B. Alternatively, there may be a single dorsal projection 420B. Dorsal projections 420A and 420B extend from dorsal coupler 430 at substantially a 90-degree angle from a plane defined by the length of arms 410A and 4108. “Substantially” in this context means plus or minus 15 degrees. A substantially perpendicular bend in the distal direction may be included in dorsal projections 420A and 420B. “Substantially” in this context means plus or minus 15 degrees. In an alternative embodiment dorsal projections 420A and 420B may be adjustable such that dorsal projection 420A may be drawn closer or further away than dorsal projection 420B.

Furthermore, massage heads 425A and 425B may be removably attached to the end of dorsal projections 420A and 420B. In an alternative embodiment that contains a single dorsal projection 420B, only a single massage head 425B may be needed. Further, dorsal projections 420A and 420B may include massage heads 425A and 425B attached to the end of dorsal projections 420A and 420B, respectively. Massage heads 425A and 425B may be interchangeably connected such that massage heads 425A and 425B may be switched out for massage heads 425A and 425B of different shape and size. In an embodiment where the massage device contains electric components massage heads 425A and 425B may be percussive and/or contain a heating element to enhance the massaging effect.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A massage device comprising:
a dorsal brace that includes a first end and a second end;
a dorsal projection which attaches to the dorsal brace;
wherein the first end of the dorsal brace is connected to a first end of a first arm and wherein the first arm extends in a first direction;
wherein the second end of the dorsal brace is connected to a first end of a second arm; and
wherein the second arm extends in the first direction which is substantially parallel to the first arm.

2. The massage device of claim 1, further comprising:
a first handle connected to a second end of the first arm.

3. The massage device of claim 2, further comprising:
a second handle connected to a second end of the second arm.

4. The massage device of claim 3, wherein the first handle extends from first arm in a second direction.

5. The massage device of claim 4, wherein the second handle extends from the second arm in a second direction.

6. The massage device of claim 5, wherein the second direction is substantially perpendicular to the length of the first and the second arms.

7. The massage device of claim 1, the massage device further comprising:
a coupler that is connected to the dorsal projection such that the dorsal projection is connected to the dorsal brace by way of the coupler.

8. The massage device of claim 1 wherein a first end of the dorsal projection is attached to a dorsal brace.

9. The massage device of claim 8, the massage device further comprising:
a massage head connected to a second end of the dorsal projection.

10. The massage device of claim 1, wherein the dorsal projection contains a bend in the first direction.

11. The massage device of claim 1, the massage device further comprising a second dorsal projection.

12. The massage device of claim 11, wherein the second dorsal projection is positioned nearer to the second end of the dorsal brace than the first end of the dorsal brace.

13. The massage device of claim 12, wherein the dorsal projection is positioned nearer to the first end of the dorsal brace than to the second end of the dorsal brace.

14. The massage device of claim 13, wherein a distance between the first end of the dorsal brace and the dorsal projection is the same as a distance between the second end of the dorsal brace and the second dorsal projection.

15. A massage device comprising:
a dorsal brace;
a plurality dorsal projections extending from the dorsal brace;
wherein a first end of the dorsal brace is connected to a first end of a first arm;
wherein the first arm extends in a first direction;
wherein a second end of the dorsal brace is connected to a first end of a second arm;
wherein the second arm extends in the first direction which is substantially parallel to the first arm.

16. The massage device of claim 1, the massage device further comprising:
a first handle connected to a second end of the first arm.

17. The massage device of claim 16, the massage device further comprising:
a second handle connected to a second end of the second arm.

18. The massage device of claim 17, wherein the first handle extends from first arm in a second direction.

19. The massage device of claim 18, wherein the second handle extends from the second arm in a second direction.

20. The massage device of claim 19, wherein the second direction is substantially perpendicular to the length of the first and the second arms.
